(19) United States
(12) Patent Application Publication
(10) Pub. No.: US 2022/0405722 A1
(43) Pub. Date: Dec. 22, 2022

(54) NON-FACE-TO-FACE SECONDHAND TRANSACTION SYSTEM AND METHOD

(71) Applicant: REPOOM INC., Seoul (KR)

(72) Inventors: Jang Ho KIM, Seoul (KR); Jong Seok KIM, Gyeonggi-do (KR)

(21) Appl. No.: 17/841,544

(22) Filed: Jun. 15, 2022

(30) Foreign Application Priority Data
Jun. 15, 2021 (KR) 10-2021-0077143

(51) Int. Cl. G06Q 20/08

(52) U.S. Cl. CPC G06Q 20/0855

(57) ABSTRACT

The non-face-to-face secondhand transaction system and method are proposed. The system and method enable a non-face-to-face secondhand transaction between the seller and the purchaser of a secondhand product by providing a secondhand product intermediation space available for storage, inspection, and use of the secondhand product.

### CROSS-REFERENCE TO RELATED APPLICATION

The present application claims priority to Korean Patent Application No. 10-2021-0077143, filed Jun. 15, 2021, the entire contents of which are incorporated herein for all purposes by this reference.

### BACKGROUND OF THE INVENTION

### Field of the Invention

The present disclosure relates to a non-face-to-face secondhand transaction system. More particularly, the present disclosure relates to a non-face-to-face secondhand transaction system and method, enabling non-face-to-face secondhand transactions between sellers and purchasers by providing a variety of secondhand transaction intermediation spaces in which secondhand products are stored and sold.

### Description of the Related Art

Unless expressly indicated otherwise herein, it should not be understood that the contents described under this section constitute any related art to the claims of the present application. Although the contents are included in this section, it is not admitted that they constitute the related art.

In Korea, the total size of the secondhand transaction market was 4 trillion won in 2008 and 20 trillion won in 2020, and it was estimated that the total size would reach 24 trillion won in 2021. It is also predicted that due to the expansion of sharing economy and growth of millennials and Gen Z (generation MZ) who regard experience as more important than purchase of goods, the secondhand transaction market would expand both domestically and overseas. In Korea, most of secondhand transactions take place at secondhand transaction platforms such as Danggeun Market, Bungaejangter, etc.

However, upon using the secondhand transaction platforms, as it is difficult to determine quality and authenticity of secondhand products, fraud may be likely to occur in the transaction. Also, where transaction of a secondhand product is delayed, this would be problematic because the seller of the secondhand product has to provide a space for storing the secondhand product for a long time. In addition, under conventional secondhand transaction systems, when a transaction takes place, the seller and the purchaser have to meet each other for delivery of the product, bringing about inconvenience. In an effort to solve such a problem to meet each other, those systems that allow secondhand transactions to proceed without contact in such a space as a vending machine or the like have been introduced. However, as the secondhand products that can be accommodated in the vending machine are very limited, secondhand products large in size or requiring special management are difficult to be dealt in by way of secondhand transactions.

### DOCUMENTS OF RELATED ART

Patent Documents
(Patent Document 1) Korean Patent No. 10-2084125 B registered on Feb. 26, 2020
(Patent Document 2) Korean Patent No. 10-2211645 B registered on Jan. 28, 2021

### SUMMARY OF THE INVENTION

Accordingly, the present disclosure has been made keeping in mind the above problems occurring in the related art, and an objective of the present disclosure is to provide a non-face-to-face secondhand transaction system and method, enabling non-face-to-face secondhand transactions between sellers and purchasers by providing secondhand transaction intermediation spaces available for storage, inspection, and use of the secondhand products before transaction.

According to an exemplary embodiment of the present disclosure, secondhand transaction intermediation spaces available for inspection and use of a variety of secondhand products including high-end audio apparatuses, rare records, expensive musical instruments, electronic appliances, luxury sports goods, leisure goods, designer sneakers, designer bags, expensive electronic appliances, home cafe appliances, etc., are provided, thereby enabling purchasers to purchase secondhand products after sufficient use and inspection before transaction. In addition, in exemplary embodiments of the present disclosure, the sellers are allowed to sell secondhand products by consignment in the secondhand transaction intermediation spaces, making it possible to reduce the sellers' individual spaces and time used for the secondhand transactions.

In order to achieve the objective of the present disclosure, the present disclosure provides a non-face-to-face secondhand transaction intermediation system including: a seller's terminal configured to register sale information of a secondhand product to be sold, including a type of the product, and the period in which the product was used, and a desired sale price thereof; a purchaser's terminal configured to register purchase information of a secondhand product including a type of a product to be purchased, a desired purchase price thereof, and a desired point in time to purchase the product; a secondhand transaction intermediation space configured to collect and store secondhand products, in which use of the stored secondhand products is available; and a secondhand transaction intermediation server configured to manage the sale information and the purchase information of the secondhand products, calculate purchase prices and sale prices of the secondhand products, rental fee of the secondhand transaction intermediation space, and sales agency fee, and manage the secondhand transaction intermediation space.

Preferably, the secondhand transaction intermediation space may be divided into an experiencing space and a product consignment space. The experiencing space may include: an audio and electronic apparatus experiencing space equipped with listening facilities and being available for use of high-end audio apparatuses; a playing space being available for performance and use of musical instruments; a sports goods experiencing space being available for use of leisure and sports goods; and a fitting space being available for fitting of clothes and bags, and the product consignment space is a product storage space configured to store secondhand products and may include a storage type storage space, a cabinet type storage space, a safe type storage space, and a showroom type storage space.

A non-face-to-face secondhand transaction intermediation method according to another embodiment of the present disclosure may include: (A) registering, with a seller's terminal, sale information of a secondhand product to be sold, including a type of the product, the period in which the product was used, and a desired sale price of the product, and consigning storage and sale of the secondhand product; (B) registering, with a purchaser's terminal, purchase information of a secondhand product to be purchased, including a type and a desired purchase price of the product, and a desired point in time to purchase the product, and registering an application for use of the product consigned on the secondhand transaction intermediation space; (C) updating the sale information and the purchase information of the secondhand products, and information on secondhand transaction intermediation spaces at a secondhand transaction intermediation server, and checking the application for use of the secondhand product; (D) performing a secondhand product transaction at the purchaser's terminal when use of the secondhand product is completed in the secondhand transaction intermediation space; and (E) when it is confirmed at the secondhand transaction intermediation server that transaction of the secondhand product has been completed, delivering the sold secondhand product to the purchaser, and sending the seller of the secondhand product a notice to advise completion of the sale.

The present disclosure is advantageous in that the non-face-to-face secondhand transaction system and method enables highly reliable non-face-to-face transactions between the parties involving in the secondhand transactions by providing spaces available for storage, inspection, and use of the secondhand products before transaction and an O2O (online to offline) system for the secondhand transaction.

Through the embodiments, the seller of a secondhand product can consign a secondhand product safely and sell the secondhand product quickly, and the purchaser of the secondhand product can use the product to purchase without worry about failure of the product, thereby being capable of enhancing satisfaction of the transaction between the seller and the purchaser of the secondhand product.

Also, secondhand transaction and resale of those products that require for special care in handling and transportation, including high-end audio apparatuses, musical instruments, etc. can also proceed quickly and safely.

Effects of the present disclosure are not limited to the effects described above, and the present disclosure includes all effects that can be deduced from the configurations of the invention described in the detailed description or the claims.

### BRIEF DESCRIPTION OF THE DRAWINGS

The above and other objectives, features, and other advantages of the present disclosure will be more clearly understood from the following detailed description when taken in conjoint with the accompanying drawings, in which:

FIG. 1 is a diagram illustrating a non-face-to-face secondhand transaction system in accordance with an embodiment of the present disclosure;

FIG. 2 is a diagram illustrating types of secondhand product storage spaces in accordance with an embodiment of the present disclosure;

FIG. 3 is a diagram illustrating showrooms and experiencing spaces among transaction intermediation spaces for secondhand products in accordance with an embodiment of the present disclosure;

FIG. 4 is a block diagram illustrating data processing of a secondhand product transaction intermediation server 200 in accordance with an embodiment of the present disclosure;

FIG. 5 is a signal flow chart of a non-face-to-face secondhand transaction intermediation system in accordance with an embodiment of the present disclosure; and

FIG. 6 is a diagram illustrating operation examples of secondhand transaction intermediation spaces in accordance with an embodiment of the present disclosure.

### DETAILED DESCRIPTION OF THE INVENTION

Hereinafter, exemplary embodiments of the present disclosure will be described in detail with reference to the accompanying drawings.

The advantages and features of the present disclosure, and methods of achieving them will be clearly understood from the following detailed description of the embodiments with reference to the accompanying drawings. It should be understood that the present disclosure may be variously embodied in many different forms, without being limited to the exemplary embodiments disclosed below. The exemplary embodiments described below are merely presented to make complete disclosure of the invention, and are provided for allowing those having ordinary knowledge in the art to more clearly comprehend the present disclosure, and the present disclosure is defined only by the appended claims. Wherever possible, the same reference numerals will be used throughout the drawings and the description to refer to the same or like elements.

In the following description, it is to be noted that, when it is determined that the detailed description of the known art related to the present disclosure may obscure the gist of the present disclosure, the detailed description will be omitted. Further, technical terms, as will be mentioned hereinafter, are terms defined in consideration of their function in the present disclosure, which may be varied according to the intention of a user or an operator, practice, or the like, so that the terms should be defined based on the contents of this specification.

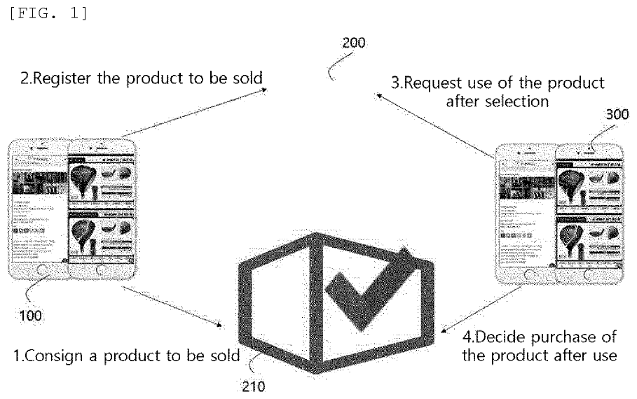

FIG. 1 is a diagram illustrating a non-face-to-face secondhand transaction system in accordance with an embodiment of the present disclosure.

Referring to FIG. 1, a non-face-to-face secondhand transaction system in accordance with the embodiment may include a seller's terminal 100, a secondhand transaction intermediation server 200, a secondhand transaction intermediation space 210, and a purchaser's terminal 300.

The seller's terminal 100 is a portable terminal of a seller who desires to sell a secondhand product, and sale information of the secondhand product to be sold, including a type of the product, the period in which the product was used, and a desired sale price of the product, is registered with the seller's terminal 100. According to the embodiment, the sale information of the secondhand product is detailed information of the secondhand product which the seller desires to sell, which may include seller registration information and data available to prove quality, price, and value of the secondhand product, including a point in time when the product was purchased, a period in which the product was used, state and authenticity information of the product, etc.

The purchaser's terminal 300 is a portable terminal of a purchaser who desires to purchase a secondhand product, and purchase information of the secondhand product is registered with the purchaser's terminal 300 by the purchaser. According to the embodiment, the purchase information of the secondhand product is detailed information of the secondhand product which the purchaser desires to purchase, which may include a desired purchase price and a type of the product to be purchased, a desired point in time to purchase, a state of the product, an area for transaction, etc.

The secondhand transaction intermediation server 200 calculates a reasonable transaction price by each secondhand product on the basis of the registered sale information and the registered purchase information of the secondhand product. The secondhand transaction intermediation server 200 also calculates the purchase price and the sale price of the secondhand product, rental fee of a transaction intermediation space for the secondhand product, and sales agency fee.

In the non-face-to-face secondhand transaction system in accordance with the embodiment, the secondhand transaction intermediation space 210 is a space for storing a secondhand product consigned from a seller of the secondhand product and provides a person who desires to purchase the secondhand product with an opportunity to use the secondhand product before transaction. For example, the secondhand transaction intermediation space 210 collects and stores a secondhand product from a seller who consigns storage and sale of the secondhand product, and receives an application for use of the product from a purchaser, thereby enabling the purchaser to use and fit the stored secondhand product before transaction. Specifically, the secondhand product intermediation space in accordance with the embodiment may include an audio and electronic apparatus experiencing space equipped with listening facilities and being available for use of high-end audio apparatuses; a playing space being available for using and playing musical instruments; a sports goods experiencing space being available for using leisure and sports goods; a fitting space being available for fitting of clothes and bags; and a storage space configured to store secondhand products.

The secondhand product intermediation space in accordance with the embodiment may be controlled in terms of temperature and humidity according to properties of the stored products, and may be equipped with facilities for security, fire prevention, disaster prevention, mothproof, and protection against snow. In addition, the secondhand transaction intermediation space remotely communicates with the secondhand transaction intermediation server and may transmit temperature and humidity data sensed by a temperature and humidity sensor to the secondhand transaction intermediation server and receive a temperature and humidity control signal from the secondhand transaction intermediation server.

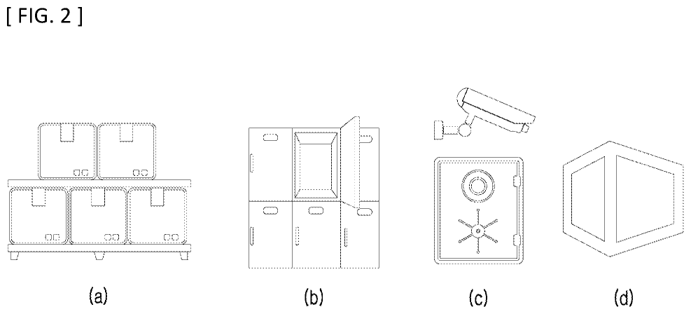

FIG. 2 is a diagram illustrating types of secondhand product storage spaces in accordance with an embodiment of the present disclosure.

Referring to FIG. 2, the secondhand product storage space may be of a storage type (a), a cabinet type (b), a safe type (c), and a showroom type (d). In the embodiment, products available for box packaging are stored in the storage type (a) storage space. Where the seller sells a product by direct packaging, the product may be delivered by the purchaser or the seller. In the embodiment, where the storage type (a) storage space is used, a product-dedicated box and an RF ID are provided, thereby allowing the seller and the purchaser to participate in the secondhand transaction more conveniently. In the cabinet type (b) storage space, products whose packaging is difficult are stored. In the embodiment, if an empty cabinet is selected by the seller, the cabinet is rented, thereby enabling the secondhand products to be stored and sold therein. In the embodiment, RF ID tags are provided to the cabinet type storage space and the secondhand products stored therein, thereby serving to improve stability in transaction. In the safe type (c) storage space, products such as valuables and things in kind, etc. may be stored. In the embodiment, the safe type (c) storage space is managed by use of passwords, thereby enabling the products subject to transaction to be managed safely. Bulky secondhand products such as cafe appliances, furniture, etc. are allowed to be displayed and sold in the showroom type (d) storage space.

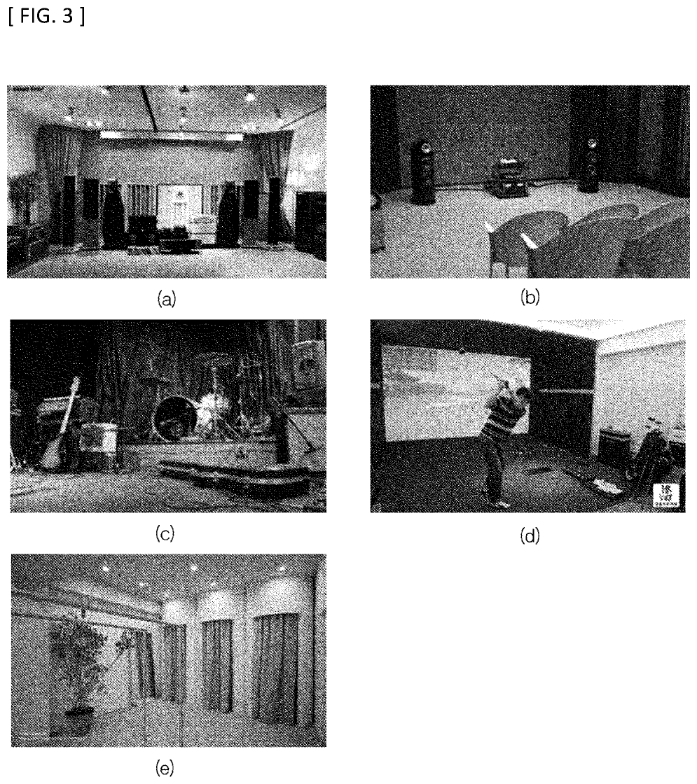

FIG. 3 is a diagram illustrating showrooms and experience spaces among intermediation spaces for secondhand product transactions in accordance with an embodiment of the present disclosure.

Referring to FIG. 3, the secondhand product transaction space in accordance with the embodiment may include an installation type exhibition and view space (a) and an experiencing space, and the experiencing space may include an audiovisual room (b), a music room (c), a screen golf room (d), and a fitting room (e).

The exhibition and view space (a) is an exhibition space for the secondhand products whose states can be checked when they are installed therein or connected thereto, for which exhibition in this space favorably affects sale of the secondhand products. For example, with respect to the secondhand products including electronic appliances such as notebook computers, game machines, limited edition DVDs, etc., secondhand products may be purchased by the purchaser after checking the states thereof and using them in the exhibition and view space (a). Of the experiencing space, the audiovisual room (b) is a space for providing an environment dedicated for watching and performance, which may be used in playing high-end audio appliances. The music room (c) is a space in which the purchaser can directly play any musical instrument to decide purchase thereof in secondhand transaction of expensive musical instruments such as guitars, violins, drums, etc. In the embodiment, the music room (c) provides an environment required for direct performance after connecting one instrument to a power source available for performance of the musical instrument or to another instrument. In case of analog musical instruments, a soundproof environment may be provided. The screen golf room (d) is a space for enabling use of expensive leisure and sports goods, in which the purchaser may directly use sports goods such as golf clubs and then decide purchase thereof. For example, where the secondhand product is a golf club, a screen golf-associated video is provided in the screen golf room (d), and where the secondhand product is a tennis racket, a tennis-associated video is provided in the screen golf room (d). In the screen golf room (d) which is one of the secondhand transaction intermediation spaces, an experiencing environment similar to the environment of using the secondhand product is provided, thereby assisting the purchaser in exactly checking the quality of the secondhand product which the purchaser desires to purchase. The fitting room (e) is a space for enabling the purchaser to wear and fit secondhand fashion products such as garments, bags, etc. so as to purchase any of them, in which privacy of the purchaser is protected. In the embodiment, the fitting room (e) maintains an environment for preventing deformation of the fashion goods. In the case of expensive brand-name products, they can be stored and used in a space equipped with security facilities.

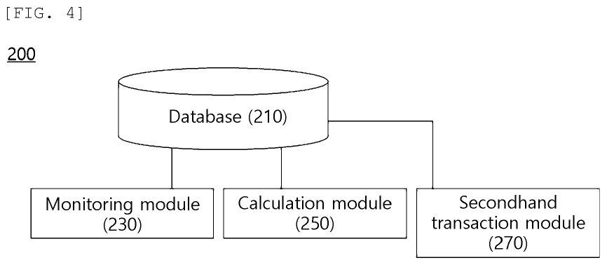

FIG. 4 is a block diagram illustrating data processing of a secondhand product transaction intermediation server 200 in accordance with an embodiment of the present disclosure.

Referring to FIG. 4, the secondhand product transaction intermediation server 200 in accordance with the embodiment may include database 210, a monitoring module 230, a calculation module 250, and a transaction intermediation module 270. The term “module” used herein may be interpreted to include software, hardware or a combination thereof according to the context in which the term is used. For example, software may be a machine code, firmware, an embedded code, and an application software. As another example, hardware may be a circuit, a processor, a computer, an integrated circuit, an integrated circuit core, a sensor, MEMS (Micro-Electro-Mechanical System), a hand-operated device, or a combination thereof.

In the database 210, a series of data for operation of the system and matching of the secondhand product transactions, including sale information and purchase information of the secondhand products, take-in and take-out information and transportation information of the collected secondhand products, and information of the transaction prices, etc., is stored.

The monitoring module 230 remotely controls the temperature and humidity of the secondhand product storage place according to types of the secondhand products, and manages take-in and take-out of the secondhand products. In addition, the monitoring module 230 monitors sellers and purchasers who participate in the secondhand transactions, and sorts out users who have requested sale of counterfeits, and users who have damaged the products, etc. and place them on a blacklist.

The calculation module 250 calculates rental fee of a space required for a secondhand product transaction, special service charge, sales commission, experience service charge and safe transportation charge according to types and storage periods of the secondhand products. For example, the space rental fee is a rental fee by each space type according to each storage period, and the special service charge is a charge imposed upon using a service provided from the secondhand transaction intermediation system. In the embodiment, a service for inspecting the product, a service for producing customized contents for YouTube or the like for sales promotion, etc. may be provided to the seller, and a service for preoccupying a product and a service for preoccupying use of the product may be provided to the purchaser. By charging a fee for using any of the services, the special service charge may be calculated. In the embodiment, the sales commission is imposed by the system when a secondhand transaction is closed and may be set to 3 to 5% of the transaction amount of money. The experience service charge is a fee for using a rental and experience service and may be set to 20,000 won per day or the like. The safe transportation charge including consignment delivery fee of the secondhand product and a fee of delivering the secondhand product to the purchaser may be set to about 20 percent of the actual transportation expense.

In addition, the calculation module 250 arranges the rental fee of the product consignment space in consideration of the space area and the rental period according to the property and size of a product to be sold by consignment, thereby allowing a space rental and consignment sale agreement to be concluded with the seller. For example, in the embodiment, the rental fee of the consignment space for a secondhand product to be sold may be calculated according to the type of the secondhand product storage space, the service option, and the consignment period. Specifically, the calculation module 250 may calculate the rental fee of the product consignment space according to Equation 1:

Total rental fee of consignment space (Unit: won)=(basically 20,000 won per pyeong (3.3 m²)/month+type of the space+service option)×the number of months. Equation 1

In the embodiment, the rental fee of consignment space may be set to vary depending upon the space type and service option. Any difference in the amount according to the space type and the service option may be set as in Table 1.

TABLE 1
Consignment space rental fee by each
space type and each service option

| | |
|---|---|
| Space type A | 10,000 won/month for general safe |
| | management only required for simple |
| | storage or the exhibition type |
| Space type B | 50,000 won/month for sales promotion by |
| | providing a special space for enabling |
| | purchasers to test or use an article |
| Service Option A | 50,000 won/month for continued special |
| | management required for maintaining the |
| | normal state of an article |
| Service Option B | 100, 000 won or more for examining and |
| | suggesting an accurate grade of an |
| | article to a seller with respect to the |
| | state of the article and assuring the |
| | grade to a purchaser |

In addition, the calculation module 250 calculates the space rental fee, the special service charge, the sales commission, the experience service charge, and the safe transportation charge, and on this basis calculates profit by each space for secondhand product transaction.

The transaction intermediation module 270 matches the purchaser with the seller of a secondhand product according to purchaser information and purchase information of the secondhand product, and seller information and sale information of the secondhand product. In addition, the transaction intermediation module 270 may calculate a reasonable transaction price of a secondhand product in consideration of the current market price of the secondhand product, the seller's desired sale price thereof, a desired purchase price thereof, and the period in which the product was used, the number of purchasers who are waiting to purchase the secondhand product, and the number of sellers who are waiting to sell the secondhand product. In the embodiment, the transaction intermediation module 270 calculates the reasonable transaction price of the secondhand product by subtracting the amount according to the period in which the product was used from the average price of the seller's desired sale price and the purchaser's desired purchase price of the secondhand product or increasing the appropriate transaction amount according to the number of awaiting purchasers, etc., and may match the seller with the purchaser of the secondhand product according to the calculated amount.

Further, in the embodiment, the transaction intermediation module 270 may construct life cycle data of the products uploaded onto the system, so as to maximize convenience for sale and purchase, and forecast demands of the manufacturers, and generate marketing data. For example, the transaction intermediation module 270 may bring purchase records of a consumer from a manufacturer's server linked in the process of listing the secondhand products to be sold, thereby being capable of accessing purchase history data of the products uploaded on the system.

In addition, the transaction intermediation module 270 may generate a product sales page for enabling the secondhand product to be promptly sold. For example, the transaction intermediation module 270 collects catalog data of a concerned secondhand product and thereafter may generate a condensed product sales page incorporating the most common features therein. Specifically, in the embodiment, data such as common images, clips, texts, etc. is extracted from the collected data, similar data in a certain level or more is incorporated, and they are condensed and generated in a product sales page.

Also, the transaction intermediation module 270 may provide the purchase history data of the product and the product sales page to the manufacturer as data associated with consumers' demand forecasting and marketing. In addition, when the transaction of the concerned secondhand product is finished, the transaction intermediation module 270 may also provide the manufacturer with the details of the secondhand transaction as data associated with consumers' demand forecasting and marketing. The non-face-to-face secondhand transaction intermediation system in accordance with the embodiment constructs life cycle data of the products up to production, sale, purchase, and resale of the products, and may incorporate data associated with a variety of partners and provide the manufacturers with diverse data useful to demand forecasting or marketing.

Hereinbelow, a non-face-to-face secondhand transaction intermediation method in accordance with another embodiment of the present disclosure will be described in order. The non-face-to-face secondhand transaction intermediation method would be inherently identical in operation (function) to the non-face-to-face secondhand transaction intermediation system. Accordingly, description of overlapping configurations with those of FIGS. 1 and 4 will be omitted.

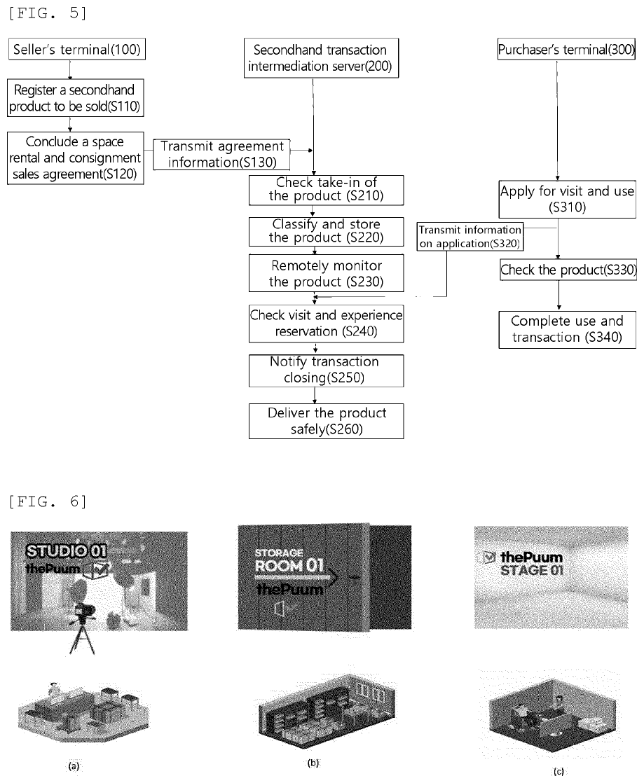

FIG. 5 is a signal flow chart of a non-face-to-face secondhand transaction intermediation system in accordance with an embodiment of the present disclosure.

Referring to FIG. 5, in the embodiment, the seller's terminal 100 registers a secondhand product to be sold with the non-face-to-face secondhand transaction intermediation system at step 110 and performs conclusion of a space rental and consignment sale agreement to sell and consign the secondhand product at step 120. Once the agreement is concluded, the agreement information is transmitted to the secondhand transaction intermediation server 200 at step 130.

The secondhand transaction intermediation server 200 checks the product consigned by the seller and take-in of the product at step 210, and classifies and stores the consigned product according to the type of the space at step 220. At step 230, the secondhand transaction intermediation server 200 remotely monitors the storage state of the product. If a purchaser conducts an application for use of a secondhand product that the purchaser desires to purchase at step 310, information of the application is transmitted to the secondhand transaction intermediation server at step S320. The secondhand transaction intermediation server 200 checks information of the visit and experience reservation by the purchaser. Where the secondhand transaction is closed after the purchaser's use, a notice to advise closing of the transaction is sent to the seller's and the purchaser's terminals. At step 260, the sold secondhand product is delivered to the purchaser.

In the embodiment, at step 120, sale information and purchase information of the secondhand product, take-in information and transportation information of the collected secondhand product, and transaction price information are stored, a temperature and humidity of a secondhand product storage space is remotely controlled according to a type of the secondhand product, and take-in and take-out of the secondhand product can be managed. In addition, the rental fee of a space required for the secondhand product transaction, the special service charge, the sales commission, the experience service charge, and the transportation charge are calculated according to the type and the storage period of the secondhand product, and an agreement for rental of a space for sale and consignment of a secondhand product and for consignment sale is conducted. In the embodiment, the rental fee of the consignment space of the product to be sold may be calculated according to the type of the secondhand product storage space, the sales agency service option, and the consignment period.

FIG. 6 is a diagram illustrating operation examples of secondhand transaction intermediation spaces in accordance with an embodiment of the present disclosure.

As illustrated in FIG. 6, the secondhand product intermediation space in accordance with the embodiment may be operated by partitioning the space into an office and reception space (a), a consignment studio (b) for storage and consignment sale by the seller of the product, and an experiencing space (c) in which the purchaser uses the secondhand product.

The non-face-to-face secondhand transaction system and method in accordance with embodiments of the present disclosure enable a non-face-to-face secondhand transaction between the seller and the purchaser of a secondhand product by providing a secondhand product intermediation space available for storage, inspection, and use of the secondhand product. In particular, through the embodiments, secondhand transaction intermediation spaces available for inspection and use of diverse secondhand products including high-end audio apparatuses, rare records, expensive musical instruments, electronic appliances, luxury sports goods, leisure goods, designer sneakers, designer bags, expensive electronic appliances, home cafe appliances, etc. are provided, enabling the purchaser to purchase a secondhand product by sufficiently using and inspecting the secondhand product before transaction. In addition, sellers are allowed to sell the secondhand product by consignment in a secondhand transaction intermediation space, which serves to reduce individual space of the seller and time used in the secondhand transaction. Further, the non-face-to-face secondhand transaction intermediation system and method in accordance with embodiments of the present disclosure enables highly reliable non-face-to-face transactions between the parties involving in the secondhand transactions by providing spaces available for storage, inspection, and use of the secondhand products and an O2O (online to offline) system for the secondhand transaction. Through this, the seller of the secondhand product can consign a secondhand product safely and sell the secondhand product quickly, and the purchaser of the secondhand product can use the product to purchase without worry about failure of the product, thereby being capable of enhancing satisfaction of the transaction between the seller and the purchaser of the secondhand product. Also, secondhand transaction and resale of those products that require for special care in handling and transportation, including high-end audio apparatuses, musical instruments, etc. can also proceed quickly and safely.

Although the present disclosure was described with reference to specific embodiments shown in the drawings, it is apparent to those of ordinary knowledge in the art that the embodiments of the present disclosure are described only for illustrative purposes and the present disclosure may be modified in various ways without departing from the scope of the present disclosure, which is described in the following claims, and thus, the protection scope of the present disclosure is not limited to the specific embodiments described above.

What is claimed is:

1. A non-face-to-face secondhand transaction intermediation system, the system comprising:
a seller's terminal configured to register sale information of a secondhand product to be sold, including a type of the product, and the period in which the product was used, and a desired sale price thereof;
a purchaser's terminal configured to register purchase information of a secondhand product to be purchased, including a type of the product, a desired purchase price thereof, and a desired point in time to purchase the product;
a secondhand transaction intermediation space configured to collect and store secondhand products, in which use of the stored secondhand products is available; and
a secondhand transaction intermediation server configured to manage the sale information and the purchase information of the secondhand products, calculate purchase prices and sale prices of the secondhand products, rental fee of the secondhand transaction intermediation space, and sales agency fee, and manage the secondhand transaction intermediation space.

2. The system of claim 1, wherein the secondhand transaction intermediation space comprises:
an audio and electronic apparatus experiencing space equipped with listening facilities and being available for use of high-end audio apparatuses;
a playing space being available for performance and use of musical instruments;
a sports goods experiencing space being available for use of leisure and sports goods;
a fitting space being available for fitting of clothes and bags; and
a product storage space configured to store secondhand products.

3. The system of claim 2, wherein the secondhand transaction intermediation space is configured to transmit temperature and humidity data sensed by a temperature and humidity sensor to the secondhand transaction intermediation server, and remotely communicate with the secondhand transaction intermediation server.

4. The system of claim 1, wherein the secondhand transaction intermediation server comprises:
database configured to store the sale information and the purchase information of the secondhand products, take-in information and transportation information of the collected secondhand products, and information of transaction prices;
a monitoring module configured to remotely control secondhand product storage spaces, temperatures and humidities of the secondhand transaction intermediation spaces according to types of the secondhand products, and manage take-in and take-out of the secondhand products;
a calculation module configured to calculate rental fees of spaces required for secondhand transaction, special service charge, sales commission, experience service charge, and safe transportation charge according to types and storage periods of the secondhand products; and
a transaction intermediation module configured to match a purchaser with a seller of a secondhand product according to purchaser information and purchase information of the secondhand product, and seller information and sale information of the secondhand product.

5. The system of claim 4, wherein the calculation module is configured to calculate rental fee of a space for consigning a secondhand product to be sold according to a storage space type of the secondhand product, a sales agency service option, and a consignment period of the secondhand product.

6. The system of claim 4, wherein the calculation module is configured to calculate rental fee of a space, special service charge, sales commission, experience service charge, and safe transportation charge, on which basis profit is calculated by each transaction intermediation space of the secondhand products.

7. The system of claim 4, wherein the transaction intermediation module is configured to calculate a reasonable transaction price of a secondhand product, in consideration of the current market price of the secondhand product, a desired sale price and a desired purchase price of the secondhand product, the period in which the secondhand product was used, the number of purchasers who are waiting to purchase the secondhand product, and the number of sellers who are waiting to sell the secondhand product.

8. A non-face-to-face secondhand transaction intermediation method using the non-face-to-face secondhand transaction intermediation system comprising a seller's terminal, a purchaser's terminal, a secondhand transaction intermediation space, and a secondhand transaction intermediation server, the method comprising:
(A) registering, with the seller's terminal, sale information of a secondhand product to be sold, including a type of the secondhand product, the period in which the secondhand product was used, and a desired sale price of the secondhand product, and consigning storage and sale of the secondhand product;
(B) registering, with the purchaser's terminal, purchase information of a secondhand product to be purchased, including a type and a desired purchase price of the secondhand product, and a desired point in time to purchase the secondhand product, and registering an application for use of the secondhand product consigned on the secondhand transaction intermediation space;
(C) updating the sale information and the purchase information of the secondhand products, and information on secondhand transaction intermediation spaces at the secondhand transaction intermediation server, and checking the application for use of the secondhand product;
(D) performing a secondhand product transaction at the purchaser's terminal when use of the secondhand product is completed in the secondhand transaction intermediation space; and
(E) when it is confirmed by the secondhand transaction intermediation server that transaction of the secondhand product has been completed, delivering the sold secondhand product to the purchaser, and sending the seller of the secondhand product a notice to advise completion of the sale.

9. The method of claim 8, wherein in step (A), rental fee of a space for consigning the secondhand product to be sold is calculated according to a storage space type, a sales agency service option, and a consignment period of the secondhand product.

10. The method of claim 8, wherein the secondhand transaction intermediation space comprises:
an audio and electronic apparatus experiencing space equipped with listening facilities and being available for use of high-end audio apparatuses;
a playing space being available for performance and use of musical instruments;
a sports goods experiencing space being available for use of leisure and sports goods;
a fitting space being available for fitting of clothes and bags; and
a product storage space configured to store secondhand products.
